(19) United States
(12) Patent Application Publication
(10) Pub. No.: US 2024/0041237 A1
(43) Pub. Date: Feb. 8, 2024

(54) JUICER ASSEMBLY FOR LARGE DIAMETER FEED TUBE

(71) Applicant: I-TECH USA, INC., FARMINGTON HILLS, MI (US)

(72) Inventors: Min Yongdu, Dongqian Lake Town Ningbo (CN); Tong Kaiyong, Dongqian Lake Town Ningbo (CN)

(21) Appl. No.: 18/080,701

(22) Filed: Dec. 13, 2022

(30) Foreign Application Priority Data
Aug. 8, 2022 (CN) 202210950191.2

(51) Int. Cl. A47J 19/02; A47J 43/07

(52) U.S. Cl. CPC A47J 19/025; A47J 43/07

(57) ABSTRACT

The juice extractor assembly with large diameter feeding pipe designed by the present invention is designed with a rotating blade connected to the feeding end of the screw, and the rotating blade is covered with a cover with a feeding pipe, and the rotating blade is in the direction of rotation of the screw. The acute angle is set on the edge. When the juicer is working, the large pieces of food are fed into the feeding pipe, and then cut by the force between the rotating blade and the feeding port, and fall into the screw part, which is achieved to a certain extent. The screw is divided into a feeding area and a pressing area. The feeding area is provided with propulsion ribs with chopping and propulsion functions, while the pressing area is equipped with screw ribs with pressing and propulsion functions.

### CROSS-REFERENCE TO RELATED APPLICATIONS

This patent application claims priority to Chinese Patent Application No. 202210950191.2 filed with the China National Intellectual Property Administration on Aug. 8, 2022, the entire disclosure of which is hereby incorporated herein by reference.

### FIELD

The invention relates to the field of juice extractors and, in particular, to a juice extractor assembly with a large-diameter feeding pipe.

### INTRODUCTION

At present, with the increasing acceptance of self-squeezed juice, juicers are becoming more and more popular as small household appliances. In the process of upgrading the juicer, customers put forward higher requirements for the convenience of product use. For example, reducing the workload of pre-grinding ingredients requires the juicer to be able to process larger food ingredients, which has a great impact on juicing. Therefore, it is necessary to design a juice extractor assembly with the function of automatically cutting large pieces of food.

### SUMMARY

In order to solve the above problems, the present invention provides a juice extractor assembly with a large-diameter feeding pipe with the function of automatically cutting large food materials.

In order to achieve the above-mentioned purpose, the present invention includes a screw, one of the end faces of the screw is a feeding end, and the feeding end of the screw is connected with a rotating blade. The rotating blade can be covered with a cover matched with the juice extractor body. The cover can cover the rotating blade completely in the horizontal and vertical directions. The cover can include a feed port connected with a feed pipe. The function of the rotating blade is to crush and cut the ingredients put into the juicer by rotating, so that there is no need to preprocess the large pieces of ingredients. The rotating blade can also reduce the workload, realize automatic cutting, and also play a stirring role. The function of the cover is to cooperate with the rotating blade to cut the ingredients. The function of the feeding tube is to feed the material. There is no limit to the length and size of the feed pipe, so the feed pipe can also temporarily serve as a storage for the food. The material is placed in the feed pipe, and the food will fall layer by layer with the cutting process of the rotating blade, which further optimizes the automatic cutting function and optimizes the user experience.

In order to adapt to the cutting of large pieces of food, a feed inlet can expose rotating blades in both the horizontal and vertical directions of the cover. The transition position between the feed pipe and the cover can be an inwardly angular protrusion. The cutting efficiency of placing ingredients from the horizontal or vertical direction alone is too low or impossible to cut, but by cutting the ingredients from both horizontal and vertical directions at the same time, large pieces of ingredients can be trapped closer to the rotating blade. In order to obtain the largest cutting volume, the design features of this juicer correspond to the area of cutting large pieces of food, so there are certain requirements for the size of the feeding port. At the same time, the extruding ribs provided can limit the falling large pieces of food in the feed port, so that the large pieces of food can be crushed and cut through the cooperation of the extruding ribs and the rotating blades.

In order to simplify the structure, the cover and the feed pipe can be conformed, and, as a non-limiting example, the ratio of the maximum diameter of the feed pipe to the cover can be greater than ¼. Combining two structural components into one structure saves costs, and at the same time can ensure the strength of the structure such as the cover to the greatest extent. On the other hand, setting the size ratio of the feed pipe to the cover reasonably cannot only ensure the connection strength of the cover but can also ensure that the inner diameter of the feeding tube is large enough to accommodate a whole orange, small apple, and other ingredients.

In order to achieve a better cutting and crushing effect and make it easier for the cut food to fall into the juice extractor, the cover can include vertical grooves distributed around the inner wall of the cover. The function of the vertical grooves is to further cooperate with the rotating blades, through the vertical grooves set at intervals, to block the ingredients from rotating with the blades, so as to achieve the effect of crushing and cutting. The round table structure with a small top and a large bottom can guide the ingredients to slide down and enter the juicing area.

In order to facilitate the cutting of food, the rotating blades can be inclined to the direction of rotation of the screw. This incline can make the food cut by the rotating blades pressed down into the juice extraction area by the side facing the food of the rotating blades under the rotation of the screw.

In order to make the rotating blade sharper and faster, the rotating blade can be provided with an acute cutting angle θ on the upper edge of the screw in the direction of rotation.

In order to make the connection between the rotating blade and the screw more stable, a thickening zone gradually increasing from top to bottom is provided at the bottom position of the rotating blade in contact with the screw. The thickening zone can increase the bearing strength of the rotating blade.

In order to connect the screw and the rotating blade, the rotating blade can include a groove on the end face of the rotating blade connected to the screw, and the screw can include a protrusion matching the groove on the end face contacting with the rotating blade. The screw and the rotating blade can be connected through the groove and the projection, so as to ensure the rotational power of the rotating blade.

In order to propel, cut, and squeeze food materials, the screw can be enlarged in one direction. The enlarged section close to the rotating blade is the feeding zone, and the stable section away from the rotating blade is the squeezing zone. The squeezing zone can include a plurality of spiral ribs, and the feeding zone can include spiral pushing ribs. The middle of the screw can include a drive shaft. The drive shaft and the rotating blade are connected by a flat key. The rotating blades are connected by a tool fixing screw, which fastens the rotating blade and is threadedly connected with the drive shaft. Two center-symmetric screwing holes can be arranged on the upper surface of the tool fixing screw. The function of the push rib is to use the spiral to push the cut food to the squeezing area. The function of the spiral rib is to squeeze the food and push the food out. The drive shaft and the rotation blades are driven by flat keys to further ensure the rotational power of the rotating blades.

In order to fix the rotating blade on the screw, the orientation of the bottom of the rotating blade is consistent with the orientation of the pushing rib on the end surface of the feeding end. The end face of the rotating blade and the pushing rib is in the same straight line, which facilitates the setting of the protrusion and the groove.

The juice extractor assembly of the large-diameter feeding pipe designed by the present invention is designed to be connected with a rotating blade at the feeding end of the screw, and is covered with a cover having a feeding pipe on the rotating blade, and the rotating blade is in the direction of rotation of the screw. The sharp angle is set on the edge of the juice extractor. When the juicer is working, the large pieces of food are fed into the feed pipe, and then cut by the sheer force between the rotating blade and the feed port, and fall into the screw part. It should be noted that the diameter of the feeding tube can reach more than 70 cm.

When in use, unpretreated small apples, oranges and other fruits can be directly put into the feeding tube, which optimizes the user experience. At the same time, the screw is divided into a feeding zone and a squeezing zone. The feeding zone is equipped with pushing ribs with the functions of chopping and pushing, while the squeezing zone is equipped with spiral ribs with pressing and pushing functions. The food residue is finally pushed out from the bottom, the structure is simplified, and the pressing efficiency is high.

### DRAWINGS

The drawings described herein are for illustrative purposes only of selected embodiments and not all possible implementations, and are not intended to limit the scope of the present disclosure.

FIG. 1 is a bottom perspective exploded view of a juicer assembly;

FIG. 2 is a left side elevational sectional view thereof;

FIG. 3 is top perspective view of the cover of the juicer assembly;

FIG. 4 is a left side elevational view of a screw and a rotating blade of the juicer assembly;

FIG. 5 is a top plan view thereof;

FIG. 6 is a left side elevational sectional view thereof; and

FIG. 7 is a top perspective view of the rotating blade and a driving shaft.

### DETAILED DESCRIPTION

In order to further explain the technical means and effects of the present invention to achieve the intended purpose of the invention, the specific implementation, structure, features and effects of the present invention will be described in detail below in conjunction with the accompanying drawings and preferred embodiments.

### EXAMPLES

### Example 1

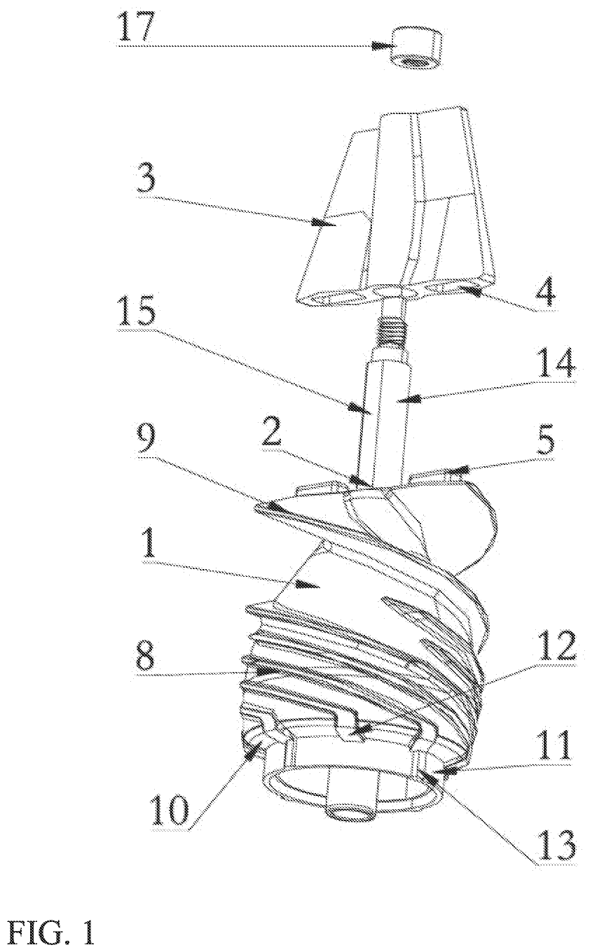

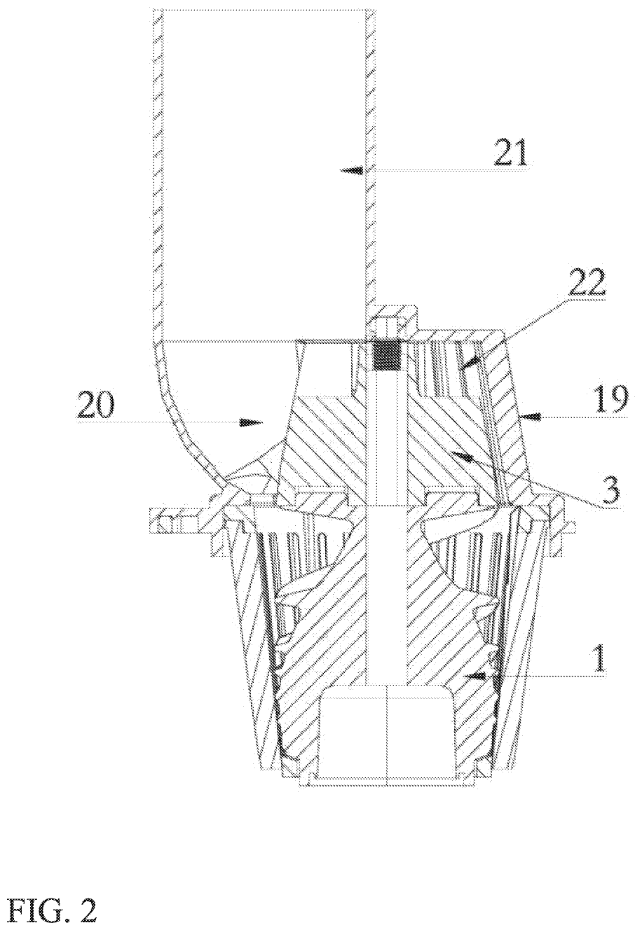

As shown in FIGS. 1-2, the juice extractor assembly of the large-diameter feed pipe described in a first embodiment can include a screw 1. One of the end faces of the screw 1 can be a feeding end 2, and the feeding end 2 of the screw 1 can be connected with rotating blade 3. The rotating blade 3 can be covered with the cover 19 that cooperates with a juice extractor body. The cover 19 can cover the rotating blade 3 completely on the horizontal and vertical directions. The cover 19 can include a feed inlet 20. A feed pipe 21 can be connected to the feed inlet 20.

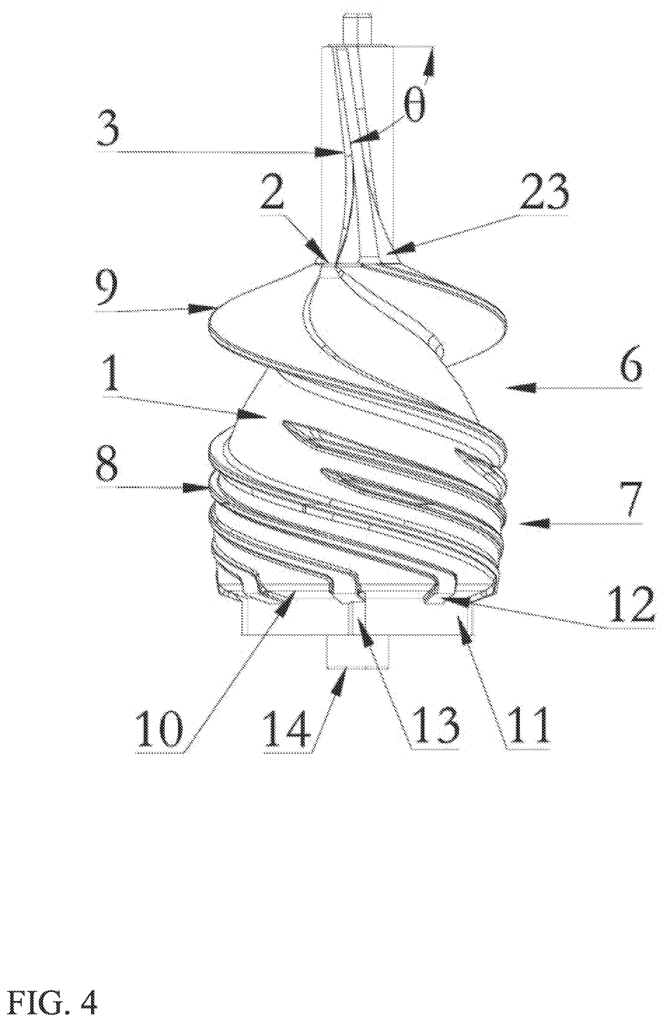

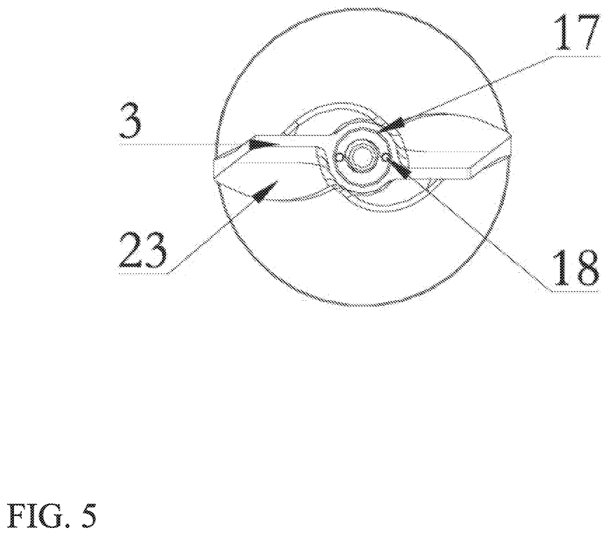

As shown in FIG. 4 and FIG. 5, the rotating blades 3 can be inclined to the rotation direction of the screw 1. The rotating blade 3 can have an acute cutting angle θ on the edge in the rotation direction of the screw 1. Additionally, the rotating blade can include a thickening zone that gradually increases from the top to the bottom at the bottom position in contact with the screw 1.

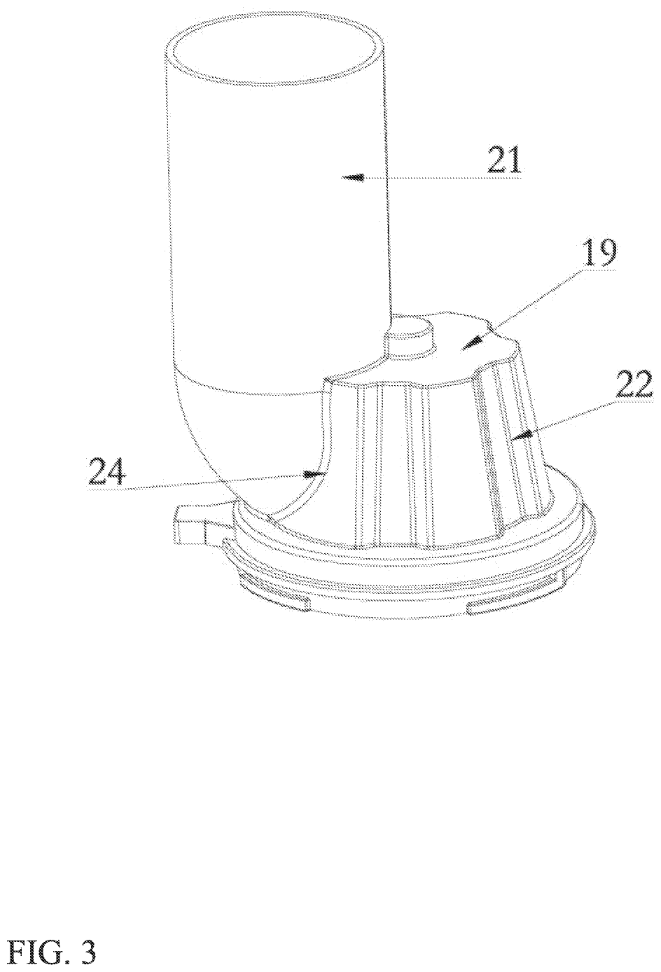

As shown in FIGS. 2-3, the feed inlet 20 can expose the rotating blades 3 in the horizontal and vertical directions of the cover 19. The ratio of the maximum diameter of the feed pipe 21 to the cover 19 can be more than ¼. The transition position between the feed port 20 and the cover 19 can include an inwardly protruding extruding rib 24. The cover 19 can be integrated with the feed pipe 21. The cover 19 can be a truncated cone with a small top and a large bottom. The cover 19 can include vertical grooves 22 evenly distributed around the circumference of the inner wall of the cover 19.

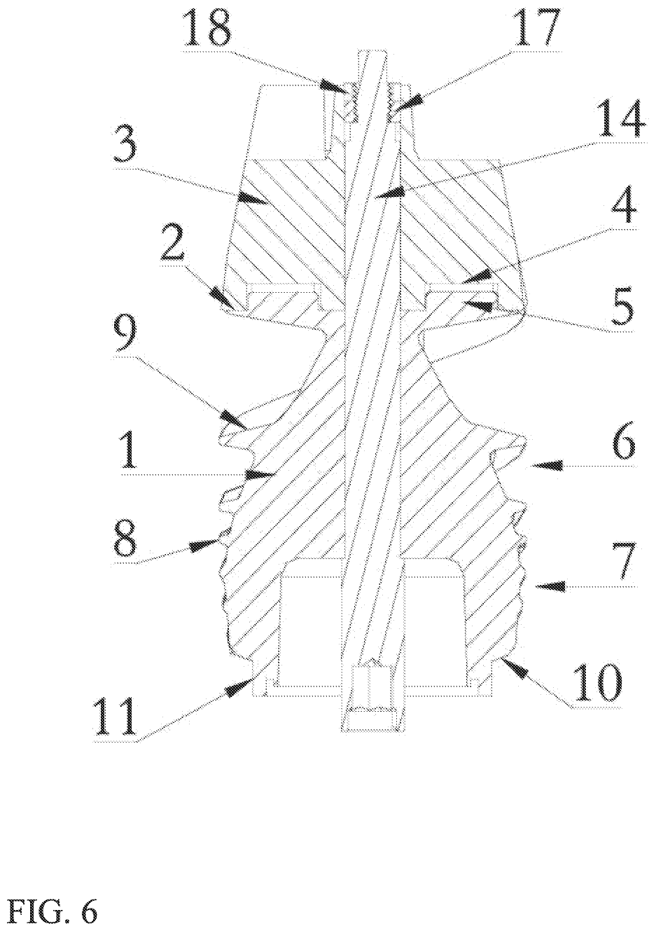

As shown in FIG. 6, the rotating blade 3 can include a groove 4 on the end surface connected with the screw 1. Additionally, the screw 1 can include a protrusion 5 that is configured to match with the groove 4 on the end surface in contact with the rotating blade 3.

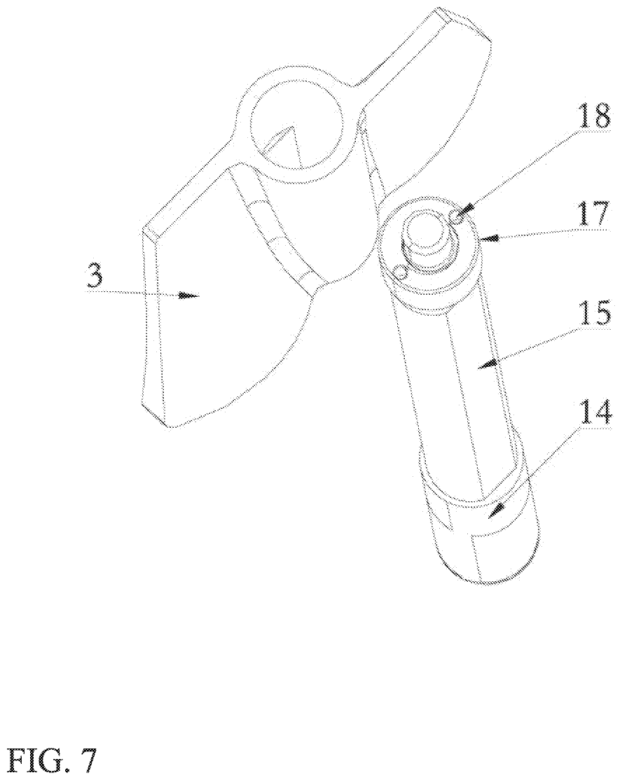

As shown in FIGS. 6-7, the screw 1 can be a one-way enlarged shape, and the enlarged section closest to rotating blade 3 can be a feeding zone 6. The steady section far away from rotating blade 3 can be a squeezing zone 7. The squeezing zone 7 can include a plurality of spiral ribs 8, and the feeding zone 6 can include a spiral pushing rib 9. The middle of the screw 1 can include a driving shaft 14, and the driving shaft 14 and the rotating blade 3 pass through a flat key 15 connection. The driving shaft 14 and the rotating blade 3 can be connected by a tool fixing screw 17. The tool fixing screw 17 can buckle the rotating blade 3 and can be threadedly connected with the driving shaft 14. The upper surface of the tool fixing screw 17 can include two centrally symmetrical screw holes 18. The direction of the bottom of the rotating blade 3 can be consistent with the direction of the pushing rib 9 on the end surface of the feeding end 2.

In the actual product, by determining the diameter of the feed pipe to be 70-74 cm, it is ensured that it can directly accommodate ingredients such as small apples and oranges, and juice extraction without pretreatment is realized.

### Example 2

As shown in FIGS. 1-2, the juice extractor assembly can include a cover 19, a screw 1, a rotating blade 3 and a driving shaft 14. The cover 19 can include a feed pipe 21 and a feed inlet 20. The feed pipe 21 can be configured to receive food from a user. The feed pipe 21 can have a variable diameter to accommodate a variety of foods. As a non-limiting example, the diameter of the feed pipe 21 can be between about 70 cm to about 74 cm. Advantageously, this can allow for small and large food to move easily through the feed pipe 21 and into the feed inlet 20. One of ordinary skill in the art can select a suitable diameter for the feed pipe 21 within the scope of the present disclosure.

With reference to FIG. 3, a portion of the feed inlet 20 can be frustoconical in shape and can include a plurality of vertical grooves 22 and extruding ribs 24. The plurality of vertical grooves 22 and extruding ribs 24 can be disposed about a portion of the circumferential surface of the feed inlet 20. As an example, the vertical grooves 22 and extruding ribs 24 can be spaced evenly about a portion of the feed inlet 20 surface. However, the vertical grooves 22 and the extruding ribs 24 can be spaced unevenly about a portion of the feed inlet 20 surface. Advantageously, this variability can allow for the juice extractor assembly to be customized for the individual needs of the user.

As shown in FIG. 4, the screw 1 can include a feeding zone 6 and a squeezing zone 7. The feeding zone 6 can include pushing ribs 9 and be disposed on an enlarged portion of the screw 1. The enlarged portion can allow for the pushing ribs 9 to be larger in size compared to other ribs disposed on the screw 1 such as those within the squeezing zone 7. Upon food leaving the food inlet 20 and entering the screw 1 of the juice extractor assembly, the pushing ribs 9 can facilitate in pushing the food down form the feeding zone 6 into the squeezing zone 7 of the screw 1 by trapping the cut-up food in the pushing ribs 9 and moving it down the screw 1 as the screw 1 rotates.

With continued reference to FIG. 4, the squeezing zone 7 can include a plurality of spiral ribs 8. The plurality of spiral ribs 8 can be smaller in size compared to the pushing ribs 9. The plurality of spiral ribs 8 can facilitate in squeezing the juice from the previously cut food in the squeezing zone 7.

With reference to FIGS. 4-7, the rotating blade 3 can be disposed within the cover 19 and connected to the screw 1. The rotating blade 3 can include a groove 4 and the screw 1 can include a protrusion 5, wherein the groove 4 is configured to receive the protrusion 5. Advantageously, this can facilitate a secure connection between the rotating blade 3 and the screw 1 such that the rotating blade 3, although not co-formed with the screw 1, can become an extension of the screw 1 and cut the food before it enters the feeding zone 6 of the screw 1.

As shown in FIG. 4, the width of the rotating blade 3 can increase from a top of the rotating blade 3 to a bottom of the rotating blade 3. The rotating blade 3 can be inclined in the same rotational direction of the screw 1 such that the rotating blade 3 acts as an extension of the screw 1. Similarly, the rotating blade 3 can be oriented to the direction of the pushing ribs 9. The rotating blade 3 can also be disposed at an acute angle relative to the screw 1, shown in FIG. 4.

With continued reference to FIGS. 4-7, the driving shaft 14 can be configured to receive the screw 1 and the rotating blade 3. The screw 1 and the rotating blade 3 can be secured to the driving shaft 14 with a tool fixing screw 17 threadedly connected to the driving shaft 14. The tool fixing screw 17 can include two screw holes 18 disposed centrally and symmetrically on the tool fixing screw 17. Desirably, this can allow for a secure connection between the screw 1 and the rotating blade 3.

The above descriptions are only preferred embodiments of the present invention, and do not limit the present invention in any form. Although the present invention has been disclosed as above with preferred embodiments, it is not intended to limit the present invention. Any person skilled in the art, without departing from the scope of the technical solution of the present invention, should be able to make use of the above-disclosed technical content with some changes or modifications to make equivalent embodiments that belong to equivalent changes. Technical Essence of the Present Invention Any brief modifications, equivalent changes and modifications made to the above embodiments still belong to the scope of the technical solution of the present invention.

What is claimed is:

1. A juice extractor assembly of a large diameter feed pipe, comprising a screw, characterized in that one of an end faces of the screw is a feeding end, and the screw on its feeding end, be connected with rotating vane, be covered with a cover that cooperates with a juice extractor body on a rotating blade, the cover on horizontal and vertical direction all completely cover the rotating blade, the cover is provided with a feeding port, and the feeding port is connected with a feeding pipe.

2. The juice extractor assembly of large diameter feed pipe according to claim 1, characterized in that, a feed inlet is exposed in both horizontal and vertical directions of the cover out of the rotating blade, a transition position between the feed inlet and the cover is provided with an inwardly convex extrusion rib.

3. The juice extractor assembly of a large diameter feed pipe according to claim 1, characterized in that, the cover is integrated with the feed pipe, and a feed pipe ratio to a largest diameter of the cover is greater than a quarter.

4. The juice extractor assembly of a large-diameter feeding pipe according to claim 1, characterized in that, the cover is a round platform with a small top and a large bottom, and the cover is provided with a vertical groove uniformly distributed on an inner wall circumference of the cover.

5. The juice extractor assembly of a large-diameter feeding pipe according to claim 1, characterized in that, the rotating blade is inclined to the rotation direction of the screw.

6. The juice extractor assembly of large diameter feed pipe according to claim 5, characterized in that, the rotating blade is provided with an acute cutting angle θ on an edge of an upper end in the direction of rotation of the screw.

7. The juice extractor assembly with a large-diameter feeding pipe according to claim 5, characterized in that, the rotating blade is set at a bottom position in contact with the screw and gradually increases from a top to bottom thickening zone.

8. The juice extractor assembly of a large-diameter feed pipe according to any one of claim 5, characterized in that, the rotating blade is provided with a groove on the end face connected to the screw, a screw rod is provided with a protrusion matching with the groove on an end surface in contact with the rotating blade.

9. The juice extractor assembly of large diameter feed pipe according to claim 8, characterized in that, the screw is enlarged in one direction, and the enlarged section close to the rotating blade is a feeding area, and a smooth section far away from the rotating blade is a squeezing zone, and the squeezing zone is provided with a plurality of spiral ribs, and on the feeding zone, a spiral pusher bar is provided; a drive shaft is provided in a middle of the screw rod, and the drive shaft is connected with the rotating blade by a flat key, and the drive shaft and the rotating blade are connected by a tool fixing screw, the tool fixing screw buckles the rotating blade and is threadedly connected with the drive shaft, a upper surface of the tool fixing screw is set, there are two centrally symmetrical screw holes.

10. The juice extractor assembly with a large-diameter feeding pipe according to claim 9, characterized in that, a bottom of the rotating blade is oriented to a direction of the pushing rib at the feeding end, the orientation on the end face is the same.

11. A juice extractor assembly of a large diameter feed pipe, comprising:
a screw;
a rotating blade connected to the screw; and
a cover having a feed inlet and a feed pipe, a plurality of vertical grooves and extruding ribs, the cover configured to cooperate with the rotating blade.

12. The juice extractor assembly of claim 11, wherein the feed pipe is co-formed with the cover.

13. The juice extractor assembly of claim 11, wherein a ratio of a diameter of the cover to a diameter of the feed pipe is greater than 1:4.

14. The juice extractor assembly of claim 13, wherein the portion of the feed inlet includes a plurality of vertical grooves uniformly distributed around a circumference of the portion.

15. The juice extractor assembly of claim 11, wherein the rotating blade is inclined in the same rotational direction of the screw.

16. The juice extractor assembly of claim 11, wherein the rotating blade is disposed at an acute angle relative to the screw.

17. The juice extractor assembly of claim 11, wherein the rotating blade includes a groove, and the screw includes a protrusion, the groove configured to receive the protrusion.

18. The juice extractor assembly of claim 11, wherein the screw includes a feeding zone and a squeezing zone, the feeding zone including pushing ribs and the squeezing zone including a plurality of spiral ribs.

19. The juice extractor assembly of claim 11, wherein the screw and the rotating blade are secured to a driving shaft with a tool fixing screw threadedly connected to the driving shaft.

20. A juice extractor assembly of a large diameter feed pipe for food, comprising:
a cover including a feed pipe and a feed inlet, the inlet having a plurality of vertical grooves and extruding ribs,
a screw including a feeding zone having pushing ribs and a squeezing zone having a plurality of spiral ribs, the pushing ribs configured to push food into the squeezing zone, and the plurality of spiral ribs configured to squeeze juice from the food;
a rotating blade disposed within the cover and connected to the screw; and
a driving shaft configured to receive the screw and the rotating blade.
